(19) United States
(12) Patent Application Publication
(10) Pub. No.: US 2002/0146094 A1
(43) Pub. Date: Oct. 10, 2002

(54) Data protective system for voice-band telecom test sets

(75) Inventor: Paul C. Brown, Grapevine, TX (US)

Correspondence Address: HAYNES AND BOONE, LLP, 901 MAIN STREET, SUITE 3100, DALLAS, TX, 75202, US

(73) Assignee: Motion Technology, Inc., Grapevine, TX

(21) Appl. No.: 10/073,473

(22) Filed: Feb. 11, 2002

Related U.S. Application Data
(60) Provisional application No. 60/270,499, filed on Feb. 21, 2001.

(51) Int. Cl. H04M 1/24; H04M 3/08; H04M 3/22

(52) U.S. Cl. 379/21

(57) ABSTRACT

A data protective system for voice-band telecom test sets is disclosed. The voice-band telecom test set includes a measurement system that can make a determination of a minimum period from an information stream on a telephone line. The test set also includes a first circuit for determining a transmission technology from the minimum period and a second circuit for selectively connecting the test set to the telephone line in response to the determination of the transmission technology.

### CROSS REFERENCE TO RELATED APPLICATIONS

This application claims the benefit of U.S. Provisional Patent Application Serial No. 60/270,499, filed on Feb. 21, 2001.

### BACKGROUND SECTION

This invention relates generally to telephone test equipment, and more specifically, to a system for protecting a data line from unintended interference from a test set.

A “craft test set” and “butt-in set” are common voice-band test sets used in the telephone/telecom industry. Essentially a ruggedized telephone, a test set is used in the field by installation and repair technicians to verify proper telephone line operation and to troubleshoot installation and maintenance problems.

There are many different types of telephone lines, including those used to convey high-speed data (non-voice) traffic such as ISDN (Integrated Services Digital Network) or T1 (data carrier), as well as voice communications. Often, it is undesirable for a technician to connect a voice-band test set to a telephone line carrying data traffic because the test set can corrupt the data. Therefore, many manufacturers of test sets incorporate data protective circuits. The purpose of such circuits is to detect the presence of high-speed data, and if detected, to prevent the completion of an electrical connection of the voice-band test equipment to the telephone line.

At the inception of high-speed data usage, telephone lines were dedicated to its conveyance, and there was no reason to allow the connection of voice-band test sets to such lines. Data protective circuits therefore simply detected the presence of any data outside the voice band and prevented connection of the test set if such data was detected.

Recently, however, transmission technologies such as DSL (Digital Subscriber Line) have emerged which simultaneously carry both voice-band signals and high-speed data traffic. On such lines, voice-band test sets equipped with data protective circuits that always prevent connection of the set to the phone line whenever high-speed data is present are rendered unusable.

To address this problem, some test set manufacturers have added a defeat switch to manually disable the data protective circuitry. While use of such a disable function does permit completion of the connection of the test set to the telephone line for voice band use, it also defeats the protection afforded by the data detection circuit in cases where test set connection must be prevented. Since there is often no visual distinction between “data-only,” “voice-only” and “data-plus-voice” telephone lines, the inadvertent use of the defeat switch with the test set connected to a “data-only” line would result in the same level of data corruption that would occur if the test set were not provided with a data protective circuit at all.

What is needed is a system and method which can be employed either to advise the operator when it is safe to use the “defeat” switch or to activate and de-activate data protection automatically.

### SUMMARY

A technical advance is achieved by a new and improved data protective system for voice-band telecom test sets. In one embodiment, a voice-band telecom test set includes a measurement system that can make a determination of a minimum period from an information stream on a telephone line. The test set also includes a first circuit for determining a transmission technology from the minimum period and a second circuit for selectively connecting the test set to the telephone line in response to the determination of the transmission technology.

In some embodiments, the test set includes an audio/visual device for externally indicating a type of information stream.

The present invention also provides software that can run on a processor associated with the test set. In one embodiment, the software includes instruction for converting the minimum period into a frequency measurement and determining a transmission technology from the frequency measurement. Once the transmission technology is determined, the software can compare the transmission technology with a set of rules and selectively connect the test set to the telephone line according to the rules.

### BRIEF DESCRIPTION OF THE DRAWINGS

FIG. 1 is an illustration of an exemplary test set for implementing one embodiment of the present invention.

FIGS. 2-3 are timing diagrams for discussing methods of detecting data on a telephone line.

FIGS. 4-6 are schematics of circuitry that can be used by the test set of FIG. 1 for detecting data according to the diagram of FIG. 3.

FIG. 7 is a flow chart implemented by a processor included in the circuitry of FIGS. 4-6.

### DETAILED DISCLOSURE

The present disclosure relates to telephone test equipment, such as can be used with different types of telephone lines. It is understood, however, that the following disclosure provides many different embodiments, or examples, for implementing different features of the invention in specific applications. These embodiments are, of course, merely examples and are not intended to limit the invention from that described in the claims.

The present disclosure is divided into five different sections. The first section describes an exemplary system for implementing one embodiment of the present invention. The second section describes a new method for detecting data on a telephone line. The third section describes a period-based data protective system using the method. The fourth section describes several software routines for use by the previously described data protective system. The fifth section concludes by describing some of the many advantages of the systems and methods previously discussed.

Exemplary System

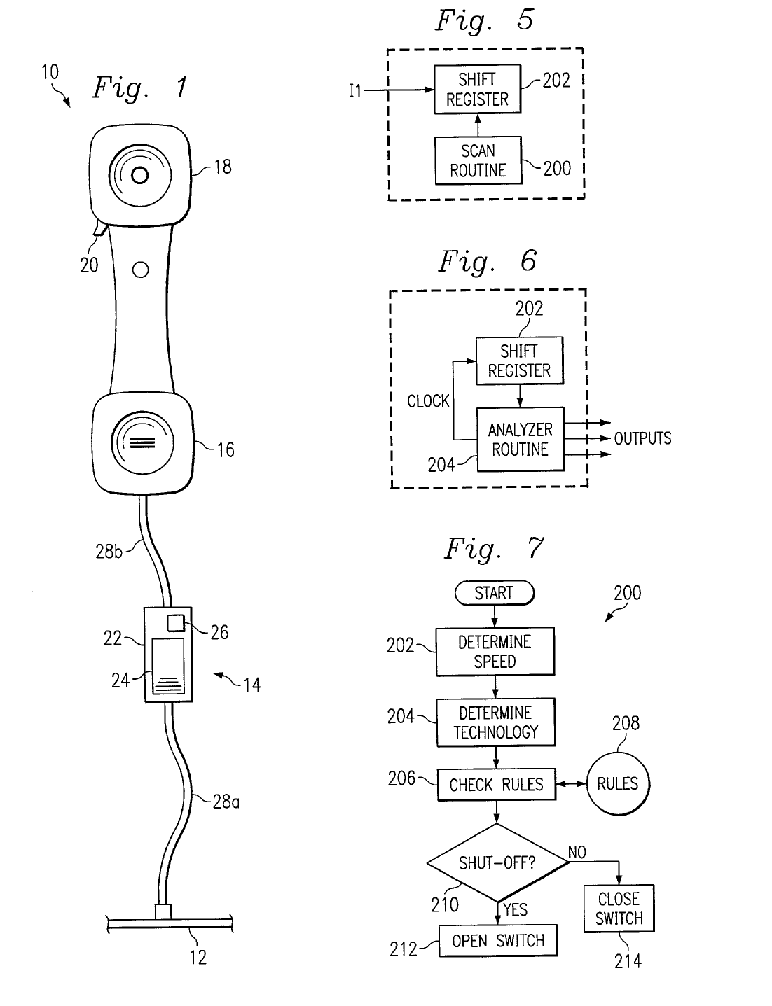

Referring to FIG. 1, a test set 10 is selectively connectable to a telephone line 12 through an in-line data protector 14. The in-line data protector 14 accurately tests for a digital signal when the telephone line 12 is to be seized by the test set 10. If the digital signal is detected, the in-line data protector 14 prevents the line 12 from being seized. In some embodiments, the in-line data protector 14 may provide an audio indication, such as disclosed in U.S. Ser. No. 09/379,186, which is hereby incorporated by reference.

The test set 10 is a conventional device, including a mouth piece 16, an ear piece 18, and a switch 20. The switch allows the test set 10 to be selectively placed in either an on-hook or off-hook condition, for selectively opening or closing, respectively, a loop with the TIP and RING lines of the telephone line 12 (or other appropriate connection for different types of telephone lines). The test set 10 can operate in a talk mode while being connected (off-hook) with the telephone line 12, or a monitor mode while being disconnected (on-hook) with the telephone line.

The in-line data protector 14 includes a plastic shell 22 having a removable opening 24 for receiving a battery such as a 9 Volt battery. The plastic shell 22 also includes a test switch actuator 26 for selectively activating an electric circuit, discussed in greater detail below. The in-line data protector 14 also includes two intermediate lines 28a and 28b for connecting to the telephone line 12 and the test set 10, respectively. Connections to the telephone line 12 and the test 10 may be any type of conventional connection, such as a wire clip connection or a jack-type connection. For the present disclosure, when the intermediate line 28a and the telephone line 12 are connected, they can be considered as one and the same. Likewise, when the intermediate line 28b and the test set 10 are connected, they too are considered as one and the same.

Data Detection Methods

A commonly-used method of detecting the presence of data being transmitted over metallic lines utilizes frequency measurements, that is, the counting of signal transitions over a specified period of time. Using a single detection band to cover the entire range of frequencies associated with data transmission is an effective way to simply determine the presence or absence of data. This method, however, is unreliable in indicating the rate of data transmission. Knowing the rate of data transmission can be a key to identifying the type of data being conveyed. Although some methods break the detection spectrum into multiple frequency bands, this still may not provide an accurate data rate indication in some situations.

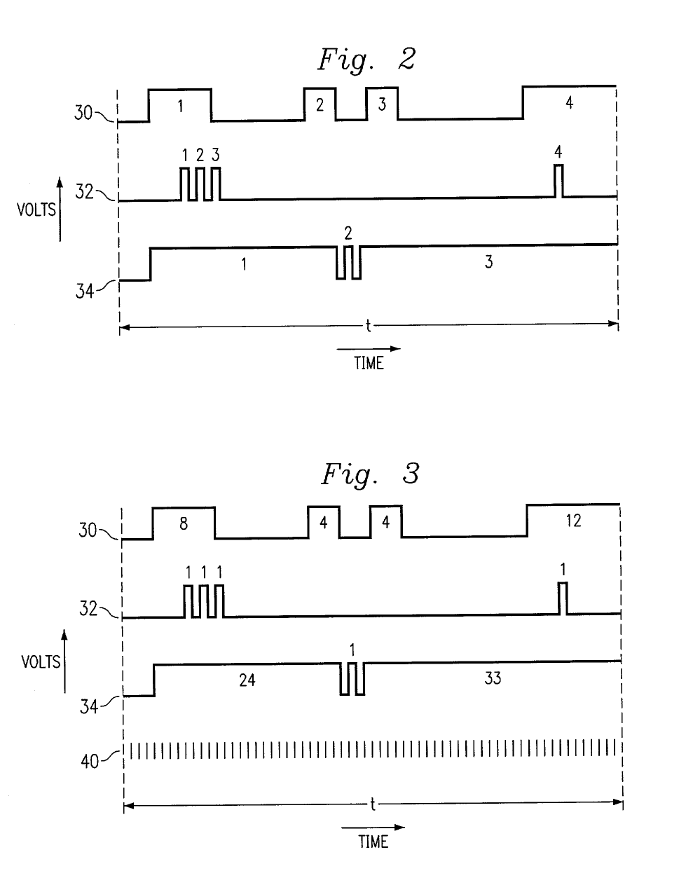

Referring to FIG. 2, there are shortcomings when using a frequency measurement to imply data rate. For example, consider three data streams 30, 32, 34 that may appear on a data/voice telephone line. The frequency of the low-rate data stream 30 indicates a reading of four pulses during the measurement time t. The high-rate data stream 32 is illustrated with a low duty cycle. In this case, the fact that four pulses are again counted would falsely indicate that the data in stream 32 has the same rate as that in stream 30.

In a more extreme case, the high-rate data transitioning at a sufficiently low duty cycle in stream 34 actually appears to have a lower rate than the data stream 30, producing a count of only three pulses during the measurement time. In such cases, while frequency measurement does indicate the presence of data activity, it cannot be relied upon to imply the rate of data transmission. Because the frequency method can only indicate a pulse count over a defined amount of time, a small number of high-frequency pulses at a low duty cycle could still be mistaken for a lower frequency at a higher duty cycle, even if a number of different frequency measurement times were used.

Instead of making frequency measurements, the present method detects high-speed data by measuring a “minimum period” of individual data pulses. One technique for doing this first takes a real-time “digital snapshot” of the data stream, then analyzes the period of the individual data pulses in the snapshot. The shortest measured pulse period is the minimum period, which is used as an indicator of transmission rate. Looking again at the examples previously given, period analysis yields a more accurate result.

Referring to FIG. 3, the same three data streams 30, 32, 34 are illustrated, for comparing with the method of FIG. 2. In addition, a series of equally spaced period increments 40 are provided during a digital snapshot of time t. The period increments 40 are spaced relatively close together, as compared with the potential pulse widths of the various streams 30-34.

The stream 30-34 have both positive and negative pulses, but for the sake of clarity and ease of description, only the positive pulses will be further discussed. The number of period increments 40 in a single positive pulse is called an “event.” The data stream 30 has events of 8, 4, 4 and 12 period increments; the data stream 32 has events of 1, 1, 1, and 1 period increments; and the data stream 34 has events of 24, 1 and 33 period increments.

The shortest measured event for a particular stream indicates that streams minimum period. The minimum period for data stream 30 is 4; the minimum period for the data stream 32 is 1; and the minimum period for the data stream 34 is 1. Keeping in mind that the shorter the minimum period observed, the higher the data rate, the data stream 30 clearly has a lower data rate than streams 32 and 34.

The “digital snapshot” technique offers several advantages in “period method” data detection. For one, both positive and negative pulses may be captured for measurement. Also, data captured at high speed can be analyzed at a lower speed, enabling implementation of the entire process using a microcontroller. Further, analysis of the “snapshot” can be made in multiple passes if necessary.

Since the period method can be used to determine the presence of different speeds of data, it can, by implication, indicate the presence of different types of data. A microcontroller implementing this method can provide outputs to indicate data speed as well as outputs to control connection to the line depending on data speed.

An Exemplary Period-Based Data Protective Circuit

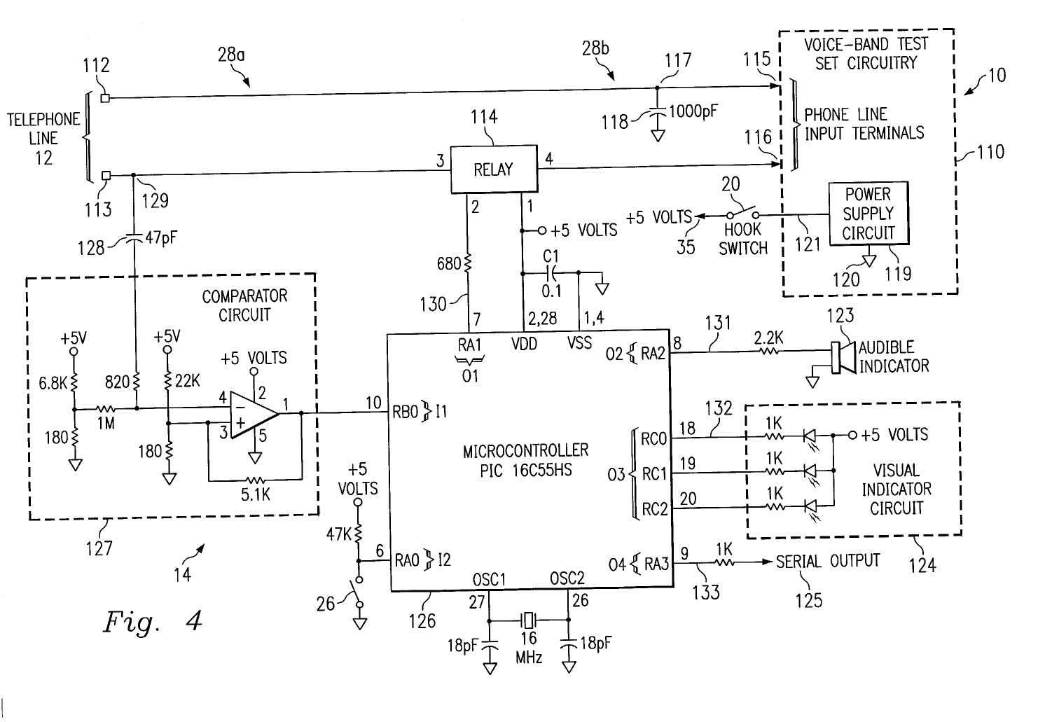

Referring now to FIG. 4, the in-line data protector 14 for the test set 10 may be implemented in many different ways, such as being separate from the physical test set (as herein illustrated), or combined with additional test set circuitry 110.

The test set circuitry 110 connects to the intermediate lines 28b through input terminals 115 and 116, which are selectively connected to the telephone line 12. Input terminal 115 connects directly to a terminal 112 of the telephone line 12, but input terminal 116 connects to a telephone line terminal 113 only through solid-state relay 114. Therefore, connection of the test set 10 to the telephone line 12 can only be completed when solid-state relay 114 closes the path there between.

The solid state relay 114 is controlled by a microcontroller 126 of the in-line data protector 14. In the present embodiment, output O1 of the microcontroller 126 turns the solid-state relay 114 on (closed) or off (open) through a control line 130.

In addition to output O1, microcontroller 126 can also optionally provide outputs to other circuitry. In one embodiment, output O2 activates an audible indicator 123 through control line 131. Output O3 activates a visual indicator circuit 124 through a set of control lines 132. Output O4 operates a serial output 125 through control line 133. The serial output 125 may be used to convey information such as the rate of detected data from in-line data protector 14 to other circuitry in test set 10 or to external devices. One purpose of such other circuitry or devices would be to provide a more elaborate display of data activity.

A comparator circuit 127 is connected to the intermediate line 28a at a tap point 129 through a D.C. blocking capacitor 128. The comparator circuit 127 converts digital data pulses present on the intermediate line 28a to a voltage level suitable to input I1 of the microcontroller 126. The opposite side of the intermediate line 28a is established as a reference for the input of comparator circuit 127 by the connection of an A.C. coupling capacitor 118 between the telephone line circuit at 117 and the internal return or “circuit ground” of power supply 119 of test set 10.

The in-line data protector 14 may be powered separately, or by the test set 10. In the present embodiment, a regulated +5 Volt D.C. output 121 of power supply circuit 119 is connected to the circuits of in-line data protector 14 through the HOOK switch 20, so that a regulated +5 Volt D.C. power is applied to the in-line data protector 14 whenever HOOK switch 20 is closed. Although the HOOK switch 20 is a manually operated device in this embodiment, the function of the HOOK switch 20 could, in other applications, be performed by an automatic switching circuit incorporated into the test set 10.

To operate the test set 10 with the in-line data protector 14 installed as set forth in this embodiment, the operator first opens the HOOK switch 20 and connects the inputs 112 and 113 to the telephone line 12. The operator then closes the HOOK switch 20 to complete connection of the test set 10 to the telephone line circuit. Upon the closure of the HOOK switch 20, +5 Volt power is applied to the in-line data protector 14. With the initial application of power, the microcontroller 126 holds the solid-state relay 114, the audible indicator 123 and the visual indicator circuit 124 in an “off” condition, and does not output data at the serial output 125. Alternatively, an initializing string of data could be generated, such as for the serial output 125. The microcontroller 126 then begins execution of a period-based data detection program, using the data stream at input I1. High-speed data pulses present on the telephone line are continuously detected by comparator circuit 127 and provided to the microcontroller 126 at input I1.

Upon detection of the presence of high-speed data pulses, the microcontroller 126 determines an appropriate action based upon a set of rules pre-programmed into its memory. For example, detection of data at speeds indicative of ISDN or T1 service could be programmed to disallow activation of solid-state relay 114 and to activate audible indicator 123, visual indicator circuit 124, and/or serial output 125. However, detection of data at speeds indicative of ADSL (Asynchronous DSL) service may briefly activate the audible and visual indicators and then activate solid-state relay 114, while outputting a different signal at the serial output 125. Thus the dedicated “data-only” services that might be disrupted by connection of the Voice-Band Test Set would be protected, while the presence of high-speed data would not preclude voice-band testing on “data-plus-voice” lines. To the extent that their data speeds were indicative of their transmission technology, future data services could be similarly accommodated by adding to the rules pre-programmed into the memory of microcontroller 126.

Should special conditions require connection of the Voice-Band Test Set to data-carrying lines otherwise protected by the Data Protective System, closure of disable switch 26 causes microcontroller 126 to activate solid-state relay 114, regardless of its detection of data and interpretation of its pre-programmed rules. However, the visual and audible indicators could still warn the operator of the presence of high-speed data.

Software Routines

As described above, the embodiments of FIG. 4 utilize a micro-controller for period-based data detection. It is understood, however, that other embodiments may utilize different electrical circuits. Continuing with the above-described embodiments, the single-chip microcontroller executes a control program to implement a serial shift register that works in conjunction with a scan routine (FIG. 5) and an analyzer routine (FIG. 6). With reference to FIG. 4, the shift register is part of the microcontroller that receives input data from input I1. The software continually repeats the routines discussed below.

Referring now to FIG. 5, a scan routine 200 is used to take a digital snapshot by capturing input data (e.g., from data streams 30-34, FIG. 2) into the shift register 202. The scan routine 200 clocks the serial shift register 202 at a fast rate n times, where n is the bit length of the shift register. In one embodiment, the shifting rate produces period increments that correspond to the shortest possible data pulse (i.e., the minimum event size equals the shortest data pulse). In this way, a minimum period can be captured and stored in a single bit of the shift register. As a result, the captured data represents a digital snapshot of the data stream.

Referring now to FIG. 6, once the digital snapshot has been obtained, an analyzer routine 204 analyzes the data. The analyzer routine 204 clocks data out of the shift register, counting the number of bits in each captured high and low input signal interval. Minimum high and low interval lengths are saved in individual registers (not shown). As data in the shift register is analyzed, each high and low interval is compared to the stored minimum, and replaces the minimum if its period is shorter. The analyzer routine 204 thereby determines the minimum period for the received data stream.

Referring now to FIG. 7, once the minimum period has been determined, a rule routine 200 may be used to control the relay 114 (FIG. 4). Execution begins at step 202 where a frequency measurement is determined from the minimum period. At step 204, a transmission technology is determined from the frequency. Referring to Table 1, below, it is known, for example, that ADSL operates at a predetermined frequency range, T1 operates at another frequency range, ISDN operates at yet another frequency range, and so forth. Further analysis may be used if any of the frequency ranges for different technologies overlap.

TABLE 1

| Transmission Technology | Data Frequency |
|---|---|
| ADSL | 0.2-1 Mbs |
| T1 | 1.544 Mbs |
| ISDN | 64 Kbs or 128 Kbs |

At step 206, once the transmission technology has been determined, a set of rules 208 is checked. The rules may indicate specific outputs (e.g., outputs O2, O3, O4 of the microcontroller 126, FIG. 4) corresponding to the identified technology. These output signals may include:

i. an output signal controlling connection of the voice-band test to the line based upon the rate of detected data;

ii. a set of control lines to a group of visual indicators which cause individual indicators to illuminate upon detection of data at different rates;

iii. a squarewave output driving an audible beeper whose beep rate and/or frequency increases or decreases according to the rate of detected data; and/or

iv. an output signal conveying a digital word representing data rate to external equipment or circuitry.

At step 210, a determination is made whether to open or close the relay 114. This determination may be made exclusively from the rules 208, or may consider other inputs, such as from the disable switch 26. At steps 212, 214, the relay 114 is opened or closed accordingly.

It is understood that other modifications, changes and substitutions are intended in the foregoing disclosure and in some instances some features of the disclosure will be employed without corresponding use of other features. Accordingly, it is appropriate that the appended claims be construed broadly and in a manner consistent with the scope of the disclosure.

We claim:

1. A telecom test device for connecting to a telephone line carrying an information stream, the device comprising:
a measurement system connected to the device, wherein the measurement system can make a determination of a minimum period from the information stream;
a first circuit for determining a transmission technology from the minimum period; and
a second circuit for selectively connecting the device to the telephone line in response to the determination of the transmission technology.

2. The test device of claim 1 wherein first and second circuits include portions of a programmed microcontroller.

3. The test device of claim 1 further comprising:
means for externally indicating a type of information stream.

4. The test device of claim 1 wherein the measurement system includes a register for taking a digital snapshot of the information stream.

5. The test device of claim 1 wherein the second circuit selectively prevents data of only a predetermined data rate.

6. The test device of claim 3 further comprising:
an audio output device for externally indicating the transmission technology.

7. The test device of claim 3 further comprising:
a visual output device for externally indicating the transmission technology.

8. The test device of claim 3 further comprising:
a digital output device for externally indicating the transmission technology.

9. The test device of claim 1 further comprising:
a manual override for temporarily disabling the second circuit.

10. A software program for use by a telephone test device for connecting to a telephone line carrying an information stream, the device including a measurement system for making a determination of a minimum period from the information stream, the software program comprising instructions for:
converting the minimum period into a transmission rate measurement;
determining a transmission technology from the transmission rate measurement;
comparing the transmission technology with a set of rules;
selectively connecting the analysis device to the telephone line according to the rules.

11. The software program of claim 10 further comprising instructions for:
externally indicating the transmission type.

12. A method for determining a data transmission technology on a transmission medium, the method comprising:
receiving a high-rate synchronization signal for providing a plurality of period increments, the high-rate being greater than or equal to a minimum pulse for data on the transmission medium;
counting the period increments from the high-rate synchronization signal during a pulse of data on the transmission medium;
determining the data transmission technology from the counted period increments.

13. The method of claim 12 further comprising:
counting the period increments from the high-rate synchronization signal during another pulse of data on the transmission medium; and
comparing the period increments counted from both pulses of data on the transmission medium to determine a minimum period increment.

14. The method of claim 13 wherein the two pulses occur in a single period.

15. The method of claim 13 wherein the two pulses are of the same polarity (positive or negative) in two consecutive periods.

16. The method of claim 12 further comprising:
providing an indication of the transmission technology to a telecom test set.

17. The method of claim 12 wherein the period increments are determined by a transition in the high-rate synchronization signal.

18. The method of claim 12 wherein the period increments indicate a positive transition in the high-rate synchronization signal.

19. The method of claim 12 further comprising:
counting the period increments from the high-rate synchronization signal during another pulse of data on the transmission medium; and
determining the data transmission technology from the counted period increments from both pulses.
